(19) United States
(12) Patent Application Publication
(10) Pub. No.: US 2022/0162491 A1
(43) Pub. Date: May 26, 2022

(54) CURABLE COMPOSITION, HEAT STORAGE MATERIAL, AND ARTICLE

(71) Applicant: Showa Denko Materials Co., Ltd., Tokyo (JP)

(72) Inventors: Naoki FURUKAWA, Chiyoda-ku, Tokyo (JP); Tsuyoshi MORIMOTO, Chiyoda-ku, Tokyo (JP); Atsuko SANO, Chiyoda-ku, Tokyo (JP); Hiroshi YOKOTA, Chiyoda-ku, Tokyo (JP)

(73) Assignee: Showa Denko Materials Co., Ltd., Tokyo (JP)

(21) Appl. No.: 17/437,412

(22) PCT Filed: Jan. 21, 2020
(86) PCT No.: PCT/JP2020/002002

§ 371 Date: Sep. 8, 2021

(30) Foreign Application Priority Data
Mar. 14, 2019 (JP) PCT/JP2019/010596

(51) Int. Cl. C09K 5/06; C08L 35/02

(52) U.S. Cl. CPC C09K 5/063; C08L 35/02

(57) ABSTRACT

A curable composition containing a compound represented by formula (1) and a polymerization initiator. In formula (1), R11 and R12 each independently represent a hydrogen atom or a methyl group, and R13 represents a divalent group having a polyoxyalkylene chain.

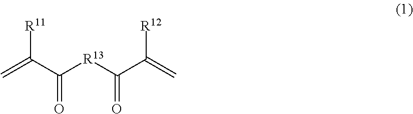

### TECHNICAL FIELD

The present invention relates to a curable composition, a heat storage material, and an article.

### BACKGROUND ART

A heat storage material is a material from which stored energy can be extracted as heat as necessary. A heat storage material is used for applications such as, for example, electronic components such as in an air conditioning device, a floor heating device, a refrigerator, and an IC chip, automobile components such as in automobile interior and exterior materials, a canister, and an insulation container.

Regarding a heat storage method, latent heat storage using a phase change in a substance is widely used in consideration of the amount of heat. Water-ice is well-known as a latent heat storage substance. Water-ice is a substance having a large amount of heat, but its phase change temperature is limited to 0° C. in the atmosphere, and thus its application range is also limited. Therefore, paraffin is used as a latent heat storage substance having a phase change temperature of higher than 0° C. and 100° C. or lower. However, paraffin becomes a liquid when its phase changes due to heating, and has a risk of ignition and combustion. Therefore, in order to use paraffin as a heat storage material, it is necessary to store it in a closed container such as a bag, and prevent paraffin from leaking from the heat storage material, and thus its application fields are limited.

Therefore, as a method of improving a heat storage material containing paraffin, for example, a method using a gelling agent is disclosed in Patent Literature 1. The gel produced by this method can be maintained as a gel-like molded product even after the phase of paraffin has changed.

### CITATION LIST

### Patent Literature

### [Patent Literature 1]

Japanese Patent Laid-Open No. 2000-109787

### SUMMARY OF INVENTION

### Technical Problem

In an aspect, an objective of the present invention is to provide a curable composition that can form a heat storage material having an excellent heat storage capacity.

### Solution to Problem

The inventors conducted extensive studies, and as a result, found that a cured product of a curable composition containing a specific compound having a polyoxyalkylene chain and two (meth)acryloyl groups has an excellent heat storage capacity, that is, the curable composition can form a heat storage material having an excellent heat storage capacity, and thus completed the present invention. The present invention provides the following [1] to [14] in some aspects.

[1] A curable composition containing a compound represented by the following Formula (1) and a polymerization initiator:

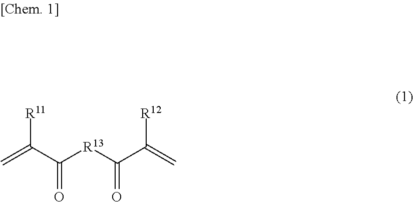

[in Formula (1), R¹¹ and R¹² each independently represent a hydrogen atom or a methyl group, and R¹³ represents a divalent group having a polyoxyalkylene chain].
[2] The curable composition according to [1], containing a compound having a weight average molecular weight of 2,000 or more and represented by Formula (1) as the compound represented by Formula (1).
[3] The curable composition according to [1], wherein the compound represented by Formula (1) is a compound represented by the following Formula (1-2):

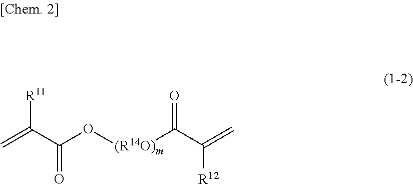

[in Formula (1-2), R¹¹ and R¹² are the same as R¹¹ and R¹² in Formula (1), R¹⁴ represents an alkylene group, and m represents an integer of 2 or more].
[4] The curable composition according to [3], wherein m is an integer such that the molecular weight of the compound represented by Formula (1-2) is 2,000 or more.
[5] The curable composition according to any one of [1] to [4], wherein the content of the compound represented by Formula (1) with respect to a total amount of the curable composition is 10 mass % or more.
[6] The curable composition according to any one of [1] to [5], further containing a compound represented by the following Formula (2):

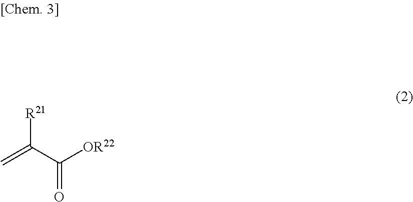

[in Formula (2), R²¹ represents a hydrogen atom or a methyl group, and R²² represents a monovalent group having a polyoxyalkylene chain].
[7] The curable composition according to any one of [1] to [6], further containing a heat storage component.
[8] The curable composition according to [7], wherein the heat storage component contains polyalkylene glycol.
[9] The curable composition according to any one of [1] to [8], further containing a compound represented by the following Formula (3):

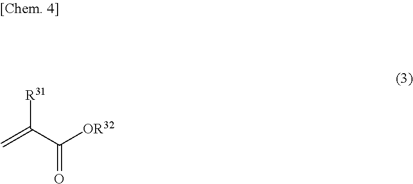

[in Formula (3), R³¹ represents a hydrogen atom or a methyl group, and R³² represents an alkyl group]
[10] The curable composition according to any one of [1] to [9], further containing a compound represented by the following Formula (4):

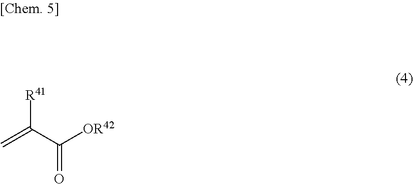

[in Formula (4), R⁴¹ represents a hydrogen atom or a methyl group, and R⁴² represents a monovalent group having a reactive group].
[11] The curable composition according to [10], further containing a curing agent that is able to react with the reactive group.
[12] The curable composition according to any one of [1] to [11], which is used for forming a heat storage material.
[13] A heat storage material containing a cured product of the curable composition according to any one of [1] to [12].
[14] An article including: a heat source; and a cured product of the curable composition according to any one of [1] to [12], which is provided in thermal contact with the heat source.

### Advantageous Effects of Invention

According to an aspect of the present invention, it is possible to provide a curable composition that can form a heat storage material having an excellent heat storage capacity.

### BRIEF DESCRIPTION OF DRAWINGS

FIG. 1 is a schematic cross-sectional view showing a heat storage material according to one embodiment.

FIG. 2 is a schematic cross-sectional view showing an article and a method of producing the same according to one embodiment.

FIG. 3 is a schematic cross-sectional view showing an article according to another embodiment.

FIG. 4 is a schematic cross-sectional view showing a method of producing an article according to another embodiment.

### DESCRIPTION OF EMBODIMENTS

Embodiments of the present invention will be appropriately described below in detail with reference to the drawings. Here, the present invention is not limited to the following embodiment.

In this specification, “(meth)acrylol” means “acryloyl” and its corresponding “methacryloyl” and the same applies to similar expressions such as “(meth)acrylate” and “(meth)acrylic.”

The weight average molecular weight (Mw) in this specification is a value which is measured using gel permeation chromatography (GPC) under the following conditions and determined using a polystyrene as a standard substance.
Measurement instrument: HLC-8320GPC (product name, commercially available from Tosoh Corporation)
Analysis column: TSKgel SuperMultipore HZ-H (3 columns connected) (product name, commercially available from Tosoh Corporation)
Guard column: TSKguardcolumn SuperMP(HZ)-H (product name, commercially available from Tosoh Corporation)
Eluent: THF
Measurement temperature: 25° C.

### [Curable Composition]

A curable composition according to one embodiment contains a compound represented by the following Formula (1) and a polymerization initiator.

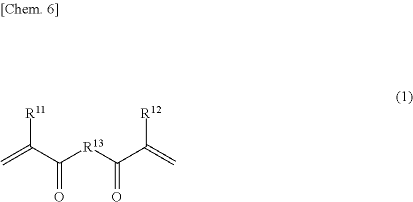

In Formula (1), R¹¹ and R¹² each independently represent a hydrogen atom or a methyl group, and R¹³ represents a divalent group having a polyoxyalkylene chain.

In one embodiment, one of R¹¹ and R¹² may be a hydrogen atom and the other may be a methyl group, in another embodiment, both R¹¹ and R¹² may be hydrogen atoms, and in another embodiment, both R¹¹ and R¹² may be methyl groups.

The polyoxyalkylene chain is represented by, for example, the following Formula (1-1).

[Chem. 7]

*—(R¹⁴O)ₘ—* (1-1)

In Formula (1-1), R¹⁴ represents an alkylene group, m represents an integer of 2 or more, and * indicates a bond.

The alkylene group represented by R¹⁴ may be linear or branched. R¹⁴ may be, for example, an alkylene group having 2 to 4 carbon atoms. A plurality of R¹⁴'s in the polyoxyalkylene chain may be the same as or different from each other. The plurality of R¹⁴'s in the polyoxyalkylene chain are one or two or more selected from the group consisting of an ethylene group, a propylene group and a butylene group, more preferably one or two selected from the group consisting of an ethylene group and a propylene group, and still more preferably, all of them are ethylene groups.

m may be, for example, an integer of 10 or more or 20 or more, and may be an integer of 300 or less, 250 or less, or 200 or less. m may be an integer such that the molecular weight of the compound represented by Formula (1) is, for example, 1,000 or more, and in order to obtain a heat storage material having a better heat storage capacity, m is preferably an integer such that the molecular weight of the compound represented by Formula (1) is 2,000 or more, 3,000 or more, 4,000 or more, 5,000 or more, 6,000 or more, or 7,000 or more. m may be an integer such that the molecular weight of the compound represented by Formula (1) is 12,000 or less, 11,000 or less, or 10,000 or less.

R³ may be a divalent group that further includes other organic groups in addition to the polyoxyalkylene chain. The other organic group may be a chain-like group other than the polyoxyalkylene chain, and may be, for example, a methylene chain (a chain having —CH₂— as a structural unit), a polyester chain (a chain having —COO— in a structural unit), or a polyurethane chain (a chain having —OCON— in a structural unit).

The compound represented by Formula (1) is preferably a compound represented by the following Formula (1-2).

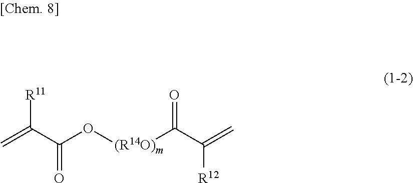

In Formula (1-2), R¹¹ and R¹² are the same as R¹¹ and R¹² in Formula (1), and R¹⁴ and m are the same as R¹⁴ and m in Formula (1-1).

The weight average molecular weight (Mw) of the compound represented by Formula (1) may be, for example, 1,000 or more, and in order to obtain a heat storage material having a better heat storage capacity, the weight average molecular weight (Mw) is preferably 2,000 or more, 3,000 or more, 4,000 or more, 5,000 or more, 6,000 or more, or 7,000 or more. The weight average molecular weight (Mw) of the compound represented by Formula (1) may be 12,000 or less, 11,000 or less, or 10,000 or less.

The curable composition may contain one compound represented by Formula (1) having the above Mw or may contain two or more compounds represented by Formula (1) having different Mws from each other. In the latter case, when the Mw of the compound represented by Formula (1) is measured by the above method, in the obtained molecular weight distribution, two or more peaks corresponding to respective Mws of two or more compounds represented by Formula (1) are observed.

In one embodiment, in order to obtain a heat storage material having a better heat storage capacity, the curable composition may preferably contain at least one compound (referred to as a compound (1A)) having an Mw of 2,000 or more or may contain at least one compound (1A) and at least one compound represented by Formula (1) (referred to as a compound (1B)) having an Mw of less than 2,000. The Mw of the compound (1A) is more preferably 3,000 or more, 4,000 or more, 5,000 or more, 6,000 or more, or 7,000 or more, and may be, for example, 12,000 or less, 11,000 or less, or 10,000 or less. The Mw of the compound (1B) may be, for example, 1,000 or more, or 1,500 or less.

The content of the compound represented by Formula (1) may be, for example, 1 mass % or more, 2 mass % or more, or 5 mass % or more with respect to a total amount of the curable composition, and in order to obtain excellent flexibility of a cured product of the curable composition and obtain a heat storage material having a better heat storage capacity, the content is preferably 10 mass % or more, 15 mass % or more, or 20 mass % or more, and more preferably 25 mass % or more, 30 mass % or more, 35 mass % or more, or 40 mass % or more. Here, if a cured product of the curable composition has excellent flexibility, for example, since the cured product that is bent can be used, the cured product is more suitable as a heat storage material that can be applied in a wider range of applications. The content of the compound represented by Formula (1) may be, for example, 99 mass % or less, 90 mass % or less, 80 mass % or less, 70 mass % or less, 60 mass % or less, or 50 mass % or less with respect to a total amount of the curable composition. When the curable composition contains two or more compounds represented by Formula (1), a total amount thereof may be in the above range. When the curable composition contains the compound (1A) and/or the compound (1B), a total amount of the compound (1A) and the compound (1B) may be in the above range, or the content of each of the compound (1A) and the compound (1B) may be in the above range.

When the curable composition further contains a compound copolymerizable with the compound represented by Formula (1) in addition to the compound represented by Formula (1) (details will be described below), the content of the compound represented by Formula (1) may be 1 part by mass or more, 2 parts by mass or more, or 5 parts by mass or more with respect to a total of 100 parts by mass of the content of the compound represented by Formula (1) and the content of the compound copolymerizable with the compound represented by Formula (1) (hereinafter referred to as “a total content of the polymerizable component”), and in order to obtain excellent flexibility of a cured product of the curable composition and obtain a heat storage material having a better heat storage capacity, the content is preferably 10 parts by mass or more or 15 parts by mass or more, more preferably 20 parts by mass or more, 25 parts by mass or more, 30 parts by mass or more, or 35 parts by mass or more, and still more preferably 40 parts by mass or more. The content of the compound represented by Formula (1) may be, for example, 99 parts by mass or less, 90 parts by mass or less, 80 parts by mass or less, 70 parts by mass or less, 60 parts by mass or less, or 50 parts by mass or less with respect to a total content of 100 parts by mass of the polymerizable component.

A polymerization initiator is not particularly limited as long as it is a compound that can initiate polymerization of the compound represented by Formula (1) and the compound copolymerizable with the compound represented by Formula (1) used as necessary (details will be described below). The polymerization initiator may be, for example, a thermal polymerization initiator that causes radicals to be generated by heat or a photopolymerization initiator that causes radicals to be generated by light.

When the curable composition contains a thermal polymerization initiator, a cured product of the curable composition can be obtained by applying heat to the curable composition. In this case, the curable composition may be a curable composition that is cured by heating at preferably 105° C. or higher, more preferably 110° C. or higher, and still more preferably 115° C. or higher, and may be, for example, a curable composition that is cured by heating at 200° C. or lower, 190° C. or lower, or 180° C. or lower. The heating time for which the curable composition is heated may be appropriately selected according to the composition of the curable composition so that the curable composition is suitably cured.

Examples of thermal polymerization initiators include azo compounds such as azobisisobutyronitrile, azobis-4-methoxy-2,4-dimethylvaleronitrile, azobiscyclohexanone-1-carbonitrile, and azodibenzoyl, and organic peroxides such as benzoyl peroxide, lauroyl peroxide, di-t-butylperoxyhexahydroterephthalate, t-butylperoxy-2-ethylhexanoate, 1,1-t-butylperoxy-3,3,5-trimethylcyclohexane, and t-butylperoxyisopropyl carbonate. These thermal polymerization initiators may be used alone or two or more thereof may be used in combination.

When the curable composition contains a photopolymerization initiator, for example, a cured product of the curable composition can be obtained by emitting light (for example, light having at least a part of wavelengths of 200 to 400 nm (ultraviolet light)) to the curable composition. Light emission conditions may be appropriately set according to the type of photopolymerization initiator.

Examples of photopolymerization initiators include a benzoin ether photopolymerization initiator, an acetophenone photopolymerization initiator, an α-ketol photopolymerization initiator, an aromatic sulfonyl chloride photopolymerization initiator, a photoactive oxime photopolymerization initiator, a benzoin photopolymerization initiator, a benzyl photopolymerization initiator, a benzophenone photopolymerization initiator, a ketal photopolymerization initiator, a thioxanthone photopolymerization initiator, and an acylphosphine oxide photopolymerization initiator.

Examples of benzoin ether photopolymerization initiators include benzoin methyl ether, benzoin ethyl ether, benzoin propyl ether, benzoin isopropyl ether, benzoin isobutyl ether, 2,2-dimethoxy-1,2-diphenylethane-1-one (product name: Irgacure 651, commercially available from BASF), and anisole methyl ether. Examples of acetophenone photopolymerization initiators include 1-hydroxycyclohexylphenyl ketone (product name: Irgacure 184, commercially available from BASF), 4-phenoxydichloroacetophenone, 4-t-butyl-dichloroacetophenone, 1-[4-(2-hydroxyethoxy)-phenyl]-2-hydroxy-2-methyl-1-propan-1-one (product name: Irgacure 2959, commercially available from BASF), 2-hydroxy-2-methyl-1-phenyl-propan-1-one (product name: Irgacure 1173, commercially available from BASF), and methoxy acetophenone.

Examples of α-ketol photopolymerization initiators include 2-methyl-2-hydroxypropiophenone, and 1-[4-(2-hydroxyethyl)-phenyl]-2-hydroxy-2-methylpropan-1-one. Examples of aromatic sulfonyl chloride photopolymerization initiators include 2-naphthalenesulfonyl chloride. Examples of photoactive oxime photopolymerization initiators include 1-phenyl-1,1-propanedione-2-(o-ethoxycarbonyl)-oxime.

Examples of benzoin photopolymerization initiators include benzoin. Examples of benzyl photopolymerization initiators include benzyl. Examples of benzophenone photopolymerization initiators include benzophenone, benzoyl benzoic acid, 3,3′-dimethyl-4-methoxybenzophenone, polyvinylbenzophenone, and α-hydroxycyclohexylphenyl ketone. Examples of ketal photopolymerization initiators include benzyl dimethyl ketal. Examples of thioxanthone photopolymerization initiators include thioxanthone, 2-chlorothioxanthone, 2-methylthioxanthone, 2,4-dimethyl thioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Examples of acylphosphin photopolymerization initiators include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzyl phosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzyl butylphosphine oxide, 2,6-dimethoxybenzoyl benzyl octylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethitoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

The above photopolymerization initiators may be used alone or two or more thereof may be used in combination.

In order to allow the polymerization to proceed favorably, the content of the polymerization initiator with respect to a total content of 100 parts by mass of the polymerizable component is preferably 0.01 parts by mass or more, more preferably 0.02 parts by mass or more, and still more preferably 0.05 parts by mass or more. In order to set the molecular weight of the polymer in the cured product of the curable composition to be within a suitable range, reduce a decomposition product, and obtain a suitable adhesive strength when it is used as a heat storage material, the content of the polymerization initiator with respect to a total content of 100 parts by mass of the polymerizable component is preferably 10 parts by mass or less, more preferably 5 parts by mass or less, still more preferably 3 parts by mass or less, and particularly preferably 1 part by mass or less.

The curable composition may further contain a compound copolymerizable with the compound represented by Formula (1). The copolymerizable compound has, for example, a group having an ethylenically unsaturated bond (ethylenically unsaturated group). Examples of ethylenically unsaturated groups include a (meth)acryloyl group, a vinyl group, and an allyl group. The copolymerizable compound is preferably a compound having a (meth)acryloyl group.

In order to obtain a heat storage material having a better heat storage capacity, preferably, the curable composition further contains a compound represented by the following Formula (2) as the copolymerizable compound.

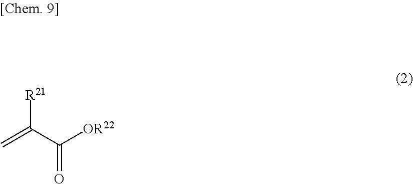

In Formula (2), R²¹ represents a hydrogen atom or a methyl group, and R²² represents a monovalent group having a polyoxyalkylene chain.

R²² may be, for example, a group represented by the following Formula (2-1).

[Chem. 10]

*—(R²³O)ₙ—R²⁴ (2-1)

In Formula (2-1), R²³ represents an alkylene group, R²⁴ represents a hydrogen atom or an alkyl group, n represents an integer of 2 or more, and * represents a bond.

The alkyl group represented by R²³ may be linear or branched. R²³ may be, for example, an alkylene group having 2 to 4 carbon atoms. A plurality of R²³'s in the polyoxyalkylene chain may be the same as or different from each other. The polyoxyalkylene chain preferably has one or two or more selected from the group consisting of oxyethylene groups, oxypropylene groups and oxybutylene groups, more preferably one or two selected from the group consisting of oxyethylene groups and oxypropylene groups, and still more preferably has only an oxyethylene group.

The alkyl group represented by R²⁴ may be linear or branched. The number of carbon atoms of the alkyl group is preferably 1 to 15, more preferably 1 to 10, and still more preferably 1 to 5. R²⁴ is particularly preferably a hydrogen atom or a methyl group.

n may be, for example, an integer of 10 or more or 20 or more, and may be an integer of 80 or less, 70 or less, or 60 or less. In order to obtain a heat storage material having a better heat storage capacity, n may be an integer such that the molecular weight of the compound represented by Formula (2) is preferably 800 or more, 900 or more, or 1,000 or more, and more preferably 1,200 or more, 1,400 or more, 1,600 or more, 1,800 or more, or 2,000 or more. n may be an integer such that the molecular weight of the compound represented by Formula (2) is 5,000 or less, 4,000 or less, 3,000 or less, or 2,500 or less.

In order to obtain a heat storage material having a better heat storage capacity, the weight average molecular weight (Mw) of the compound represented by Formula (2) is preferably 800 or more, 900 or more, or 1,000 or more, and more preferably 1,200 or more, 1,400 or more, 1,600 or more, 1,800 or more, or 2,000 or more. The weight average molecular weight (Mw) of the compound represented by Formula (2) may be 5,000 or less, 4,000 or less, 3,000 or less, or 2,500 or less.

The content of the compound represented by Formula (2) with respect to a total content of 100 parts by mass of the polymerizable component may be, for example, 10 parts by mass or more, 20 parts by mass or more, or 30 parts by mass or more, and in order to obtain a heat storage material having a better heat storage capacity, the content is preferably 40 parts by mass or more, more preferably 50 parts by mass or more, still more preferably 60 parts by mass or more, and particularly preferably 70 parts by mass or more. The content of the compound represented by Formula (2) with respect to a total content of 100 parts by mass of the polymerizable component may be, for example, 98 parts by mass or less, 90 parts by mass or less, or 80 parts by mass or less.

In order to adjust the hardness of the cured product of the curable composition and easily dissolve the polymerization initiator in the curable composition when the polymerization initiator is a solid, the curable composition may further contain a compound represented by the following Formula (3) as the compound copolymerizable with the compound represented by Formula (1).

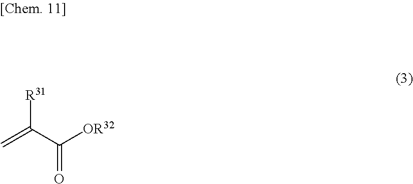

In Formula (3), R³¹ represents a hydrogen atom or a methyl group, and R³² represents an alkyl group.

The alkyl group represented by R³² may be linear or branched. The number of carbon atoms of the alkyl group may be, for example, 1 to 30. The number of carbon atoms of the alkyl group may be 1 to 11, 1 to 8, 1 to 6, or 1 to 4, or may be 12 to 30, 12 to 28, 12 to 24, 12 to 22, 12 to 18, or 12 to 14.

The content of the compound represented by Formula (3) with respect to a total content of 100 parts by mass of the polymerizable component may be, for example, 0.5 parts by mass or more, 1 part by mass or more, or 1.5 parts by mass or more, and may be 10 parts by mass or less, 8 parts by mass or less, or 6 parts by mass or less.

The curable composition may further contain a compound represented by the following Formula (4) as the compound copolymerizable with the compound represented by Formula (1).

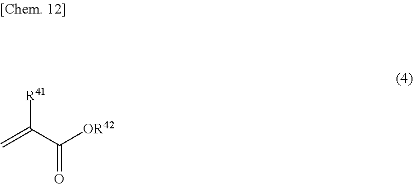

In Formula (4), R⁴¹ represents a hydrogen atom or a methyl group, and R⁴² represents a monovalent group having a reactive group.

When the curable composition further contains a compound represented by Formula (4), after the compound represented by Formula (1) and the compound represented by Formula (4) (or other compounds copolymerizable with the compound represented by Formula (1)) are polymerized, the curable composition can be additionally cured by reacting the reactive group contained in the compound represented by Formula (4) with a curing agent to be described below.

The reactive group represented by R⁴² is a group that can react with a curing agent to be described below, and is, for example, at least one group selected from the group consisting of a carboxylic group, a hydroxy group, an isocyanate group, an amino group and an epoxy group. That is, the compound represented by Formula (4) is, for example, a carboxylic group-containing compound, a hydroxy group-containing compound, an isocyanate group-containing compound, an amino group-containing compound or an epoxy group-containing compound.

Examples of carboxylic group-containing compounds include (meth)acrylate, carboxyethyl (meth)acrylate, carboxypentyl (meth)acrylate, itaconic acid, maleic acid, fumaric acid, crotonic acid, and isocrotonic acid.

Examples of hydroxy group-containing compounds include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; and hydroxyalkyl cycloalkane (meth)acrylates such as (4-hydroxymethylcyclohexyl)methyl (meth)acrylate. Examples of hydroxy group-containing compounds include hydroxyethyl (meth)acrylamide, allyl alcohol, 2-hydroxyethyl vinyl ether, 4-hydroxybutyl vinyl ether, and diethylene glycol monovinyl ether.

Examples of isocyanate group-containing compounds include 2-methacryloyloxyethyl isocyanate and 2-acryloyloxyethyl isocyanate.

The isocyanate group in the isocyanate group-containing compound may be blocked (protected) using a blocking agent (protecting group) that can be removed with heat. That is, the isocyanate group-containing compound may be a compound having a blocked isocyanate group represented by the following Formula (4-1).

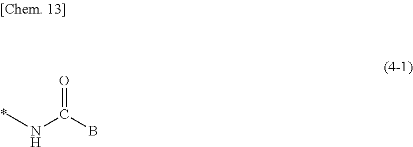

In the formula, B represents a protecting group, and * represents a bond.

The protecting group in the blocked isocyanate group may be a protecting group that can be removed (deprotected) with heat (for example, heating at 80 to 160° C.). In the blocked isocyanate group, a substitution reaction between the blocking agent (protecting group) and the curing agent to be described below may occur under deprotection conditions (for example, a heating condition of 80 to 160° C.). Alternatively, in the blocked isocyanate group, an isocyanate group may be generated due to deprotection, and the isocyanate group can also react with the curing agent to be described below.

Examples of blocking agents in the blocked isocyanate group include oxime compounds such as formaldoxime, acetaldoxime, acetoxime, methylethylketoxime, and cyclohexanone oxime; pyrazole compounds such as pyrazole, 3-methylpyrazole, and 3,5-dimethylpyrazole; lactam compounds such as ε-caprolactam, δ-valerolactam, γ-butyrolactam and β-propiolactam; mercaptan compounds such as thiophenol, methylthiophenol, and ethylthiophenol; acid amide compounds such as acetamide and benzamide; and imide compounds such as succinimide and maleic acid imide.

Examples of compounds having a blocked isocyanate group include 2-[(3,5-dimethylpyrazolyl)carbonylamino]ethyl methacrylate and 2-(0-[1′-methylpropylideneamino]carboxyamino)methacrylate.

Examples of amino group-containing compounds include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate.

Examples of epoxy group-containing compounds include glycidyl (meth)acrylate, α-ethyl glycidyl (meth)acrylate, α-n-propyl glycidyl (meth)acrylate, α-n-butyl glycidyl (meth)acrylate, 3,4-epoxy butyl (meth)acrylate, 4,5-epoxy pentyl (meth)acrylate, 6,7-epoxy heptyl (meth)acrylate, α-ethyl-6,7-epoxy heptyl (meth)acrylate, 3-methyl-3,4-epoxy butyl (meth)acrylate, 4-methyl-4,5-epoxy pentyl (meth)acrylate, 5-methyl-5,6-epoxy hexyl (meth)acrylate, β-methyl glycidyl (meth)acrylate, and α-ethyl-β-methyl glycidyl (meth)acrylate.

The content of the compound represented by Formula (4) may be, for example, 0.5 parts by mass or more, 1 part by mass or more, or 1.5 parts by mass or more and may be 10 parts by mass or less, 8 parts by mass or less, or 5 parts by mass or less with respect to a total content of 100 parts by mass of the polymerizable component.

The total content of the polymerizable component may be 30 mass % or more, 40 mass % or more, 50 mass % or more, 60 mass % or more, 70 mass % or more, 80 mass % or more, or 90 mass % or more, and may be 99.9 mass % or less with respect to a total amount of the curable composition.

When the curable composition contains the compound represented by Formula (4), the curable composition preferably further contains a curing agent. The curing agent is a compound that can react with a reactive group contained in the compound represented by Formula (4).

Examples of curing agents include an isocyanate curing agent, a phenolic curing agent, an amine curing agent, an imidazole curing agent, an acid anhydrate curing agent, and a carboxylic acid curing agent. One or a combination of two or more of these curing agents may be appropriately selected according to the type of the reactive group contained in the compound represented by Formula (4). For example, when the reactive group is an epoxy group, the curing agent is preferably a phenolic curing agent or an imidazole curing agent.

Examples of isocyanate curing agents include aromatic diisocyanates such as tolylene diisocyanate (2,4- or 2,6-tolylene diisocyanate, or mixtures thereof) (TDI), phenylene diisocyanate (m- or p-phenylene diisocyanate, or mixtures thereof), 4,4′-diphenyl diisocyanate, 1,5-naphthalene diisocyanate (NDI), diphenylmethane diisocyanate (4,4′-, 2,4′- or 2,2′-diphenylmethane diisocyanate, or mixtures thereof) (MDI), 4,4′-toluidine diisocyanate (TODI), 4,4′-diphenyl ether diisocyanate, xylylene diisocyanate (1,3- or 1,4-xylylene diisocyanate, or mixtures thereof) (XDI), tetramethyl xylylene diisocyanate (1,3- or 1,4-tetramethyl xylylene diisocyanate, or mixtures thereof) (TMXDI), and ω,ω′-diisocyanate-1,4-diethylbenzene.

Examples of isocyanate curing agents include aliphatic diisocyanates such as trimethylene diisocyanate, 1,2-propylene diisocyanate, butylene diisocyanate (tetramethylene diisocyanate, 1, 2-butylene diisocyanate, 2,3-butylene diisocyanate, 1,3-butylene diisocyanate), 1,5-pentamethylene diisocyanate (PDI), 1,6-hexamethylene diisocyanate (HDI), 2,4,4- or 2,2,4-trimethylhexamethylene diisocyanate, and 2,6-diisocyanate methyl caprate, and alicyclic diisocyanates such as 1,3-cyclopentane diisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (isophorone diisocyanate) (IPDI), methylene bis(cyclohexyl isocyanate) (4,4′-, 2,4′- or 2,2′-methylene bis(cyclohexyl isocyanate), their trans, trans-form, trans, cis-form, cis, cis-form, or mixtures thereof) (H12MDI), methyl cyclohexane diisocyanate (methyl-2,4-cyclohexane diisocyanate, methyl-2,6-cyclohexane diisocyanate), norbornane diisocyanate (various isomers or mixtures thereof) (NBDI), and bis(isocyanatomethyl)cyclohexane (1,3- or 1,4-bis(isocyanatomethyl)cyclohexane or mixtures thereof) (H6XDI).

Examples of phenolic curing agents include phenol compounds having bisphenol A, bisphenol F, bisphenol S, 4,4′-biphenylphenol, tetramethyl bisphenol A, dimethylbisphenol A, tetramethyl bisphenol F, dimethyl bisphenol F, tetramethyl bisphenol S, dimethyl bisphenol S, tetramethyl-4,4′-biphenol, dimethyl-4,4′-biphenylphenol, 1-(4-hydroxyphenyl)-2-[4-(1,1-bis-(4-hydroxyphenyl)ethyl)phenyl]propane, 2,2′-methylene-bis(4-methyl-6-tert-butylphenol), 4,4′-butylidene-bis(3-methyl-6-tert-butylphenol), trishydroxyphenylmethane, resorcinol, hydroquinone, pyrogallol, and diisopropylidene frameworks; phenol compounds having a fluorene framework such as 1,1-di-4-hydroxyphenylfluorene; cresol compounds; ethylphenol compounds; butylphenol compounds; octylphenol compounds; and various novolac resins such as novolac resins including various phenols such as bisphenol A, bisphenol F, bisphenol S, and a naphthol compound as raw materials, a phenol novolac resin containing a xylylene framework, a phenol novolac resin containing a dicyclopentadiene framework, a phenol novolac resin containing a biphenyl framework, a phenol novolac resin containing a fluorene framework, and a phenol novolac resin containing a furan framework.

Examples of amine curing agents include aromatic amines such as diaminodiphenylmethane, diaminodiphenyl sulfone, diaminodiphenyl ether, p-phenylenediamine, m-phenylenediamine, o-phenylenediamine, 1,5-diaminonaphthalene, and m-xylylenediamine, and aliphatic amines such as ethylenediamine, diethylenediamine, hexamethylenediamine, isophorone diamine, bis(4-amino-3-methyldicyclohexyl)methane, and polyether diamine; and guanidine compounds such as dicyandiamide, and 1-(o-tolyl)biguanide.

Examples of imidazole curing agents include 2-methylimidazole, 2-ethyl-4-methylimidazole, 2-phenylimidazole, 2-undecylimidazole, 2-heptadecylimidazole, 2-phenyl-4-methylimidazole, 1-benzyl-2-phenylimidazole, 1-benzyl-2-methylimidazole, 1-cyanoethyl-2-methylimidazole, 1-cyanoethyl-2-phenylimidazole, 1-cyanoethyl-2-undecylimidazole, 2,3-dihydro-1H-pyrrolo-[1,2-a]benzimidazole, 2,4-diamino-6(2′-methylimidazole(1′))ethyl-s-triazine, 2,4-diamino-6(2′-undecylimidazole(1′))ethyl-s-triazine, 2,4-diamino-6(2′-ethyl-4-methylimidazole(1′))ethyl-s-triazine, 2,4-diamino-6(2′-methylimidazole(1′))ethyl-s-triazine-isocyanuric acid adducts, 2-methylimidazole isocyanuric acid adducts, 2-phenylimidazole isocyanuric acid adducts, 2-phenyl-3,5-dihydroxymethylimidazole, 2-phenyl-4-methyl-5-hydroxymethylimidazole, and 1-cyanoethyl-2-phenyl-3,5-dicyanoethoxymethylimidazole.

Examples of acid anhydride curing agents include aromatic carboxylic anhydrides such as phthalic anhydride, trimellitic anhydride, pyromellitic anhydride, benzophenone tetracarboxylic acid anhydride, ethylene glycol trimellitic anhydride, and biphenyl tetracarboxylic acid anhydride; anhydrides of aliphatic carboxylic acids such as azelaic acid, sebacic acid, and dodecanedioic acid, and alicyclic carboxylic acid anhydrides such as tetrahydrophthalic anhydride, hexahydrophthalic anhydride, nadic anhydride, HET anhydride, and himic anhydride.

Examples of carboxylic acid curing agents include succinic acid, glutaric acid, adipic acid, sebacic acid, phthalic acid, isophthalic acid, and terephthalic acid.

The content of the curing agent with respect to a total amount of the curable composition may be 0.01 mass % or more, 10 mass % or less, 5 mass % or less, or 1 mass % or less.

In order to obtain a heat storage material having a better heat storage capacity, preferably, the curable composition further contains a heat storage component.

The heat storage component preferably contains polyalkylene glycol in order to obtain a heat storage material having a particularly excellent heat storage capacity, which does not easily exude from the cured product of the curable composition when used in combination with the compound represented by Formula (1).

The polyalkylene glycol may be, for example, polyethylene glycol, polypropylene glycol, or polybutylene glycol, and preferably polyethylene glycol.

The weight average molecular weight (Mw) of polyalkylene glycol may be 800 or more, 900 or more, or 1,000 or more, or may be 2,000 or less, 1,900 or less, or 1,800 or less.

When the curable composition contains the compound represented by Formula (2) and polyalkylene glycol, the melting point of polyalkylene glycol is preferably close to the melting point of the compound represented by Formula (2) so that the cured product of the curable composition can be suitably used as a heat storage material. The absolute value of the difference between the melting point of polyalkylene glycol and the melting point of the compound represented by Formula (2) is preferably 20° C. or lower, more preferably 15° C. or lower, and still more preferably 10° C. or lower.

The melting point of the compound represented by Formula (2) and the melting point of polyalkylene glycol are measured as follows. Using a differential scanning calorimeter (for example, model number DSC8500 commercially available from PerkinElmer Co., Ltd.), the temperature is raised to 100° C. at 20° C./min, and the temperature is kept at 100° C. for 3 minutes, and the temperature is then lowered to −30° C. at a rate of 10° C./min, and next, the temperature is kept at −30° C. for 3 minutes and the temperature is raised to 100° C. again at a rate of 10° C./min. Thus, the thermal behavior is measured, and the melting peak is calculated as a melting point.

The content of polyalkylene glycol with respect to a total content of 100 parts by mass of the polymerizable component may be 10 parts by mass or more, 20 parts by mass or more, or 30 parts by mass or more, and in order to obtain a heat storage material having a better heat storage capacity, the content is preferably 40 parts by mass or more, more preferably 50 parts by mass or more, and still more preferably 60 parts by mass or more and may be 70 parts by mass or more, 80 parts by mass or more, 90 parts by mass or more, 100 parts by mass or more, 150 parts by mass or more, 200 parts by mass or more, or 300 parts by mass or more. The content of polyalkylene glycol with respect to a total content of 100 parts by mass of the polymerizable component may be 500 parts by mass or less, 400 mass or less, 300 parts by mass or less, 200 parts by mass or less, 150 parts by mass or less, 120 parts by mass or less, 110 parts by mass or less, or 100 parts by mass or less, and in order to obtain excellent flexibility of a cured product of the curable composition, the content is preferably 90 parts by mass or less, more preferably 80 parts by mass or less, still more preferably 70 parts by mass or less, and particularly preferably 60 parts by mass or less.

The heat storage component may be contained in the curable composition as a heat storage capsule contained in the capsule. The heat storage capsule has a heat storage component and an outer shell (shell) containing the heat storage component.

The heat storage component in the heat storage capsule may be the polyalkylene glycol described above or may be another heat storage component. As the other heat storage component, for example, a component having a phase transition temperature that matches a target temperature is appropriately selected according to the purpose of use. In order to obtain a heat storage effect in a practical range, the other heat storage component has, for example, a solid phase/liquid phase transition point (melting point) exhibiting phase transition of a solid phase/liquid phase at −30 to 120° C.

The other heat storage component may be, for example, a chain-like (linear or branched (branched chain-like)) saturated hydrocarbon compound (paraffin hydrocarbon compound), natural wax, petroleum wax, or a sugar alcohol. The other heat storage component is preferably a chain-like saturated hydrocarbon compound (paraffin hydrocarbon compound) because it is inexpensive and has low toxicity and it is possible to easily select one having a desired phase transition temperature.

Specific examples of chain-like saturated hydrocarbon compounds include n-decane (C10 (number of carbon atoms, the same applies hereinafter), −29° C. (transition point (melting point), the same applies hereinafter)), n-undecane (C11, −25° C.), n-dodecane (C12, −9° C.), n-tridecane (C13, −5° C.), n-tetradecane (C14, 6° C.), n-pentadecane (C15, 9° C.), n-hexadecane (C16, 18° C.), n-heptadecane (C17, 21° C.), n-octadecane (C18, 28° C.), n-nanodecane (C19, 32° C.), n-eicosane (C20, 37° C.), n-heneicosane (C21, 41° C.), n-docosane (C22, 46° C.), n-tricosane (C23, 47° C.), n-tetracosane (C24, 50° C.), n-pentacosane (C25, 54° C.), n-hexacosane (C26, 56° C.), n-heptacosane (C27, 60° C.), n-octacosane (C28, 65° C.), n-nonacosane (C29, 66° C.), n-triacontane (C30, 67° C.), n-tetracontane (C40, 81° C.), n-pentacontane (C50, 91° C.), n-hexacontane (C60, 98° C.), and n-hectane (C100, 115° C.). The chain-like saturated hydrocarbon compound may be a branched saturated hydrocarbon compound having the same number of carbon atoms as these linear saturated hydrocarbon compounds, and chain-like saturated hydrocarbon compounds may be of one type or of two or more types.

The outer shell (shell) containing such a heat storage component is preferably formed of a material having a heat resistance temperature sufficiently higher than the transition point (melting point) of the heat storage component. The material forming the outer shell has a heat resistance temperature that is, for example, 30° C. or higher, and preferably 50° C. or higher, with respect to the transition point (melting point) of the heat storage component. Here, the heat resistance temperature is defined as a temperature at which 10% weight loss occurs when the weight loss of the capsule is measured using a differential thermogravimetric simultaneous measurement device (for example, TG-DTA6300, commercially available from Hitachi High-Tech Science Corporation)).

As the material forming the outer shell, a material having a strength according to the application of the heat storage material formed of the curable composition is appropriately selected. The outer shell is preferably formed of a melamine resin, an acrylic resin, a urethane resin, silica, or the like. Examples of micro capsules having an outer shell containing a melamine resin include BA410xxP, 6C, BA410xxP, 18C, BA410xxP, and 37C (commercially available from Outlast Technology LLC), Thermo Memory FP-16, FP-25, FP-31, and FP-39 (commercially available from Mitsubishi Paper Mills Ltd.), and Riken Resin PMCD-15SP, 25SP, and 32SP (commercially available from Mikiriken Industrial Co., Ltd.). Examples of micro capsules having an outer shell containing an acrylic resin (polymethyl methacrylate resin) include MicronalDS5001X, 5040X (commercially available from BASF). Examples of micro capsules having an outer shell containing silica include Riken Resin LA-15, LA-25, and LA-32 (commercially available from Mikiriken Industrial Co., Ltd.).

In order to further improve the heat storage effect, the content of the heat storage component in the heat storage capsule is preferably 20 mass % or more, and more preferably 60 mass % or more, and in order to inhibit breakage of the capsule due to change in the volume of the heat storage component, the content is preferably 80 mass % or less, with respect to a total amount of the heat storage capsule.

In order to adjust the thermal conductivity of the capsule, a specific gravity, or the like, the heat storage capsule may further contain graphite, a metal powder, an alcohol or the like in the outer shell.

The particle size (average particle size) of the heat storage capsule is preferably 0.1 μm or more, more preferably 0.2 μm or more, and still more preferably 0.5 μm or more, and preferably 100 μm or less, and more preferably 50 μm or less. The particle size (average particle size) of the heat storage capsule is measured using a laser diffraction particle size distribution measuring device (for example, SALD-2300 commercially available from Shimadzu Corporation).

In order to further improve the heat storage effect, the content of the heat storage capsule is preferably 20 mass % or more, more preferably 30 mass % or more, and still more preferably 40 mass % or more with respect to a total amount of the curable composition. In order to prevent the heat storage capsule from dropping out of a cured product of the curable composition, the content of the heat storage capsule is preferably 90 mass % or less, more preferably 85 mass % or less, and still more preferably 80 mass % or less with respect to a total amount of the curable composition.

In order to improve thermal reliability of a cured product (heat storage material) of the curable composition, the curable composition preferably further contains an antioxidant. The antioxidant may be, for example, a phenolic antioxidant, a benzophenone antioxidant, a benzoate antioxidant, a hindered amine antioxidant, or a benzotriazole antioxidant.

The content of the antioxidant may be 0.1 mass % or more, 0.5 mass % or more, 0.8 mass % or more, or 1 mass % or more and may be 10 mass % or less or 5 mass % or less with respect to a total amount of the curable composition, and in order to obtain excellent flexibility of a cured product of the curable composition, the content is preferably 4 mass % or less, more preferably 3 mass % or less, still more preferably 2.5 mass % or less, and particularly preferably 2 mass % or less.

The curable composition may further contain other additives as necessary. Examples of other additives include a surface treatment agent, a curing accelerator, a colorant, a filler, a crystal nucleating agent, a heat stabilizer, a thermal conductive material, a plasticizer, a foaming agent, a flame retardant, a damping agent, a dehydrating agent, and a flame retardant aid (for example, a metal oxide). These other additives may be used alone or two or more thereof may be used in combination. The content of other additives may be 0.1 mass % or more or 30 mass % or less with respect to a total amount of the curable composition.

The curable composition may be a liquid at 50° C. Thus, the curable composition can be easily provided between members having a complicated shape by a method such as filling. In this case, in order to obtain excellent flowability and handling properties, the viscosity of the curable composition at 50° C. is preferably 100 Pa·s or less, more preferably 50 Pa·s or less, still more preferably 20 Pa·s or less, and particularly preferably 10 Pa·s or less, and may be, for example, 0.5 Pa·s or more. The viscosity of the curable composition is a value measured based on JIS Z 8803, and specifically, a value measured by an E type viscometer (for example, commercially available from Toki Sangyo Co., Ltd., PE-80L). Here, the viscometer can be calibrated based on JIS Z 8809-JS14000.

Since the compound represented by Formula (1) contained in the curable composition described above is a compound having a polyoxyalkylene chain and a (meth)acryloyl group, the curable composition containing the compound represented by Formula (1) and a polymerization initiator can be cured and the obtained cured product can have an excellent heat storage capacity due to the polyoxyalkylene chain. Therefore, the curable composition is suitable as a curable composition for a heat storage material, and a cured product of the curable composition is suitable as a heat storage material.

In addition, since the compound represented by Formula (1) has two (meth)acryloyl groups, a cross-linked structure is formed in the obtained cured product. Therefore, when the curable composition contains the heat storage component (particularly polyalkylene glycol) described above, the cross-linked structure can prevent the heat storage component from exuding from the cured product. Therefore, the degree of freedom of the heat storage component that can be used is higher, and as a result, the heat storage capacity can be further improved.

### [Heat Storage Material]

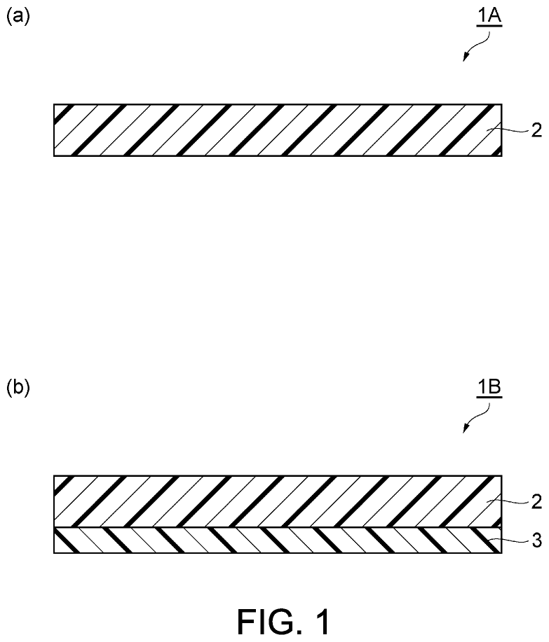

The heat storage material according to one embodiment contains the above cured product of the curable composition. FIG. 1 is a schematic cross-sectional view showing a heat storage material according to one embodiment. As shown in FIG. 1(a), a heat storage material 1A according to one embodiment is a sheet-like (or film-like) heat storage material having a heat storage layer 2 which is a cured product of the above curable composition.

As shown in FIG. 1(b), a heat storage material 1B according to another embodiment is a sheet-like (or film-like) heat storage material including the heat storage layer 2 which is a cured product of the above curable composition and an adhesive layer 3 provided on one surface of the heat storage layer 2. In this case, the heat storage material 1B can be suitably adhered to an application target of the heat storage material 1B.

In the above embodiments, the thickness of the heat storage layer 2 may be, for example, 0.01 mm or more, 0.05 mm or more, or 0.1 mm or more, and may be 20 mm or less, 10 mm or less, or 5 mm or less.

In the above embodiments, the heat storage layer 2 may be a cured product in which the curable composition is completely cured, or may be a cured product in which the curable composition is converted into the B stage (semi-cured). In the heat storage material 1A shown in FIG. 1(a), in order to suitably adhere the heat storage material 1A to an application target of the heat storage material 1A, the heat storage layer 2 is preferably a cured product in which the curable composition is converted into the B stage (semi-cured).

The adhesive layer 3 may be composed of a known adhesive. The thickness of the adhesive layer 3 may be, for example, 0.001 mm or more, 0.003 mm or more, or 0.005 mm or more, or may be 0.03 mm or less, 0.02 mm or less, or 0.015 mm or less.

The heat storage materials 1A and 1B (collectively referred to as the heat storage material 1) can be used in various fields. The heat storage material 1 is used for, for example, air conditioning devices (for improving efficiency of air conditioning devices) in automobiles, buildings, public facilities, underground malls, and the like, pipes (for heat storage of pipes) in factories and the like, engines (for heat retention around the engine) in automobiles, electronic components (for preventing increasing of the temperature of electronic components), fibers for undergarments, and the like.

The heat storage layer 2 in the heat storage material 1A or the heat storage layer 2 and the adhesive layer 3 in the heat storage material 1B described above may be provided on a support film. That is, a heat storage material according to another embodiment may include a support film and a heat storage layer 2 provided on the support film. The heat storage material according to another embodiment may include a support film, a heat storage layer 2 provided on the support film, and an adhesive layer 3 provided on the side opposite to the support film of the heat storage layer 2. The heat storage materials according to these embodiments may be, for example, formed in a long shape and wound around a winding core in the longitudinal direction (roll-shaped heat storage material).

The support film may be formed of a polymer, for example, polyethylene terephthalate, polyethylene, polyvinylidene chloride, polyester, polypropylene, polyvinyl chloride, polycarbonate, polyacrylonitrile, polyetheretherketone, polyvinyl alcohol, ethylene-vinyl alcohol copolymer, polyimide, or polyamide-imide.

The thickness of the support film may be, for example, 1 μm or more, 2 μm or more, or 3 μm or more, and may be 15 μm or less, 10 μm or less, or 7 μm or less.

### [Article and Method of Producing the Same]

Next, regarding an article including the heat storage material 1 (a cured product of the curable composition) and a method of producing the same, an electronic component will be exemplified as an object in which the heat storage material 1 is provided.

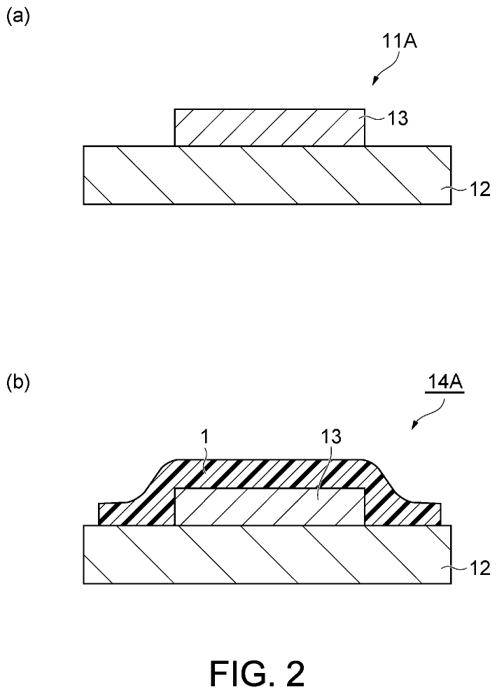

FIG. 2 is a schematic cross-sectional view showing an article and a method of producing the same according to one embodiment. In the method of producing an article according to one embodiment, first, as shown in FIG. 2(a), an electronic component 11A is prepared as an article as an object in which the heat storage material is provided. The electronic component 11A includes, for example, a substrate 12 and a semiconductor chip (heat source) 13 provided on the substrate 12.

Next, as shown in FIG. 2(b), the sheet-like heat storage material 1 is disposed on the substrate 12 and the semiconductor chip 13 so that it is in thermal contact with the substrate 12 and the semiconductor chip 13. The heat storage material 1 may be, for example, the heat storage material 1A shown in FIG. 1(a) described above or the heat storage material 1B shown in FIG. 1(b) described above. When the heat storage material 1B shown in FIG. 1(b) is used, the heat storage material 1B is disposed so that the adhesive layer 3 is in contact with the substrate 12 and the semiconductor chip 13.

When the heat storage layer in the heat storage material 1 is a cured product in which the curable composition is converted into the B stage (semi-cured), the heat storage layer is cured after the heat storage material 1 is disposed. That is, the method of producing an article according to the present embodiment may further include a process of curing the heat storage layer of the heat storage material 1 disposed on the substrate 12 and the semiconductor chip 13.

Thereby, an article 14A including the substrate 12, the semiconductor chip 13, and the heat storage material 1 (a cured product of the curable composition) provided on the substrate 12 and the semiconductor chip 13 is obtained.

In the above embodiment, the heat storage material 1 is disposed so that it covers the entire exposed surface of a heat source 13, but in another embodiment, the heat storage material may be disposed so that it covers a part of the exposed surface of the heat source.

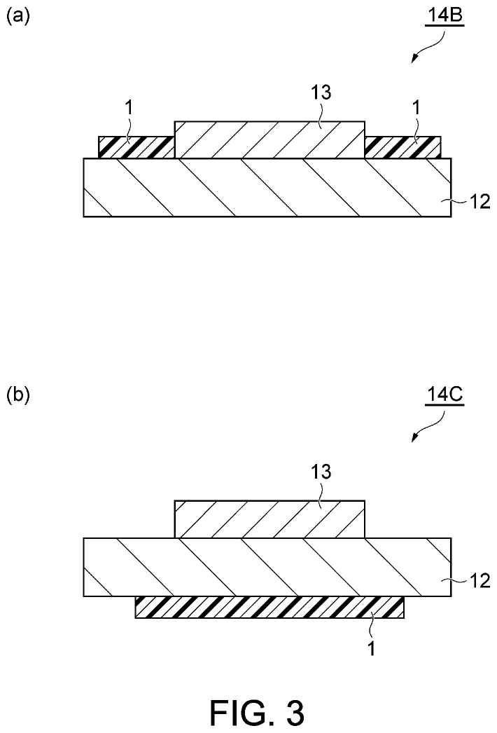

FIG. 3(a) is a schematic cross-sectional view showing an article according to another embodiment. As shown in FIG. 3(a), in an article 14B according to another embodiment, for example, the heat storage material 1 may be disposed so that it is in contact with a part (covers a part) of the exposed surface of the semiconductor chip (heat source) 13. While a part in which the heat storage material 1 is disposed (a part of the heat storage material 1 in contact with the semiconductor chip 13) is a side part of the semiconductor chip 13 in FIG. 3(a), the part may be any surface of the semiconductor chip 13.

FIG. 3(b) is a schematic cross-sectional view showing an article according to another embodiment. As shown in FIG. 3(b), in an article 14C according to another embodiment, the heat storage material 1 is disposed on the surface opposite to the surface of the substrate 12 on which the semiconductor chip 13 is provided. In the present embodiment, the heat storage material 1 is not in direct contact with the semiconductor chip 13, but is in thermal contact with the semiconductor chip 13 with the substrate 12 therebetween. A part in which the heat storage material 1 is disposed may be any surface of the substrate 12 as long as it is in thermal contact with the semiconductor chip 13. In this case, heat generated in the heat source (semiconductor chip) 13 is efficiently conducted to the heat storage material 1 with the substrate 12 therebetween, and suitably stored in the heat storage material 1.

In the production method according to the above embodiment, the heat storage material 1 is in the form of sheet, but in a production method according to another embodiment, it is possible to produce an article using a liquid curable composition (a heat storage material is formed).

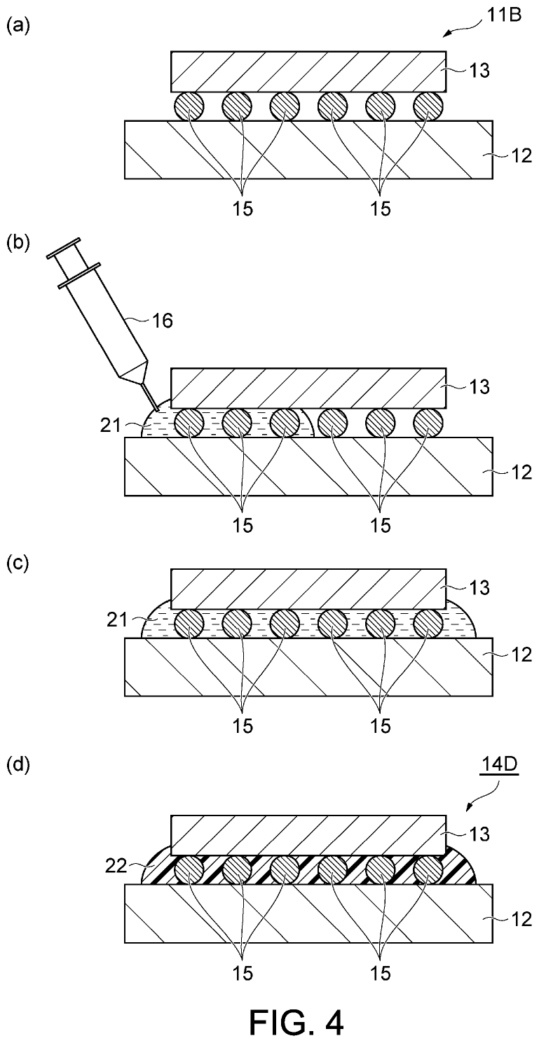

FIG. 4 is a schematic cross-sectional view showing a method of producing an article according to another embodiment. In the production method according to the present embodiment, first, as shown in FIG. 4(a), an electronic component 11B is prepared as an article as an object in which the heat storage material is provided. The electronic component 11B includes, for example, the substrate (for example, circuit board) 12, the semiconductor chip (heat source) 13 provided on the substrate 12, and a plurality of connecting parts (for example, solders) 15 that connect the semiconductor chip 13 to the substrate 12. The plurality of connecting parts 15 are provided between the substrate 12 and the semiconductor chip 13 so that they are separated from each other. That is, there are gaps between the substrate 12 and the semiconductor chip 13 so that the plurality of connecting parts 15 are separated from each other.

Next, as shown in FIG. 4(b), for example, a curable composition 21 is filled between the substrate 12 and the semiconductor chip 13 using a syringe 16. The curable composition 21 is the curable composition according to the above embodiment. The curable composition 21 may be in a completely uncured state or in a partially cured state.

When the curable composition 21 is in a liquid state at room temperature (for example, 25° C.), the curable composition 21 can be filled at room temperature. When the curable composition 21 has a solid form at room temperature, the curable composition 21 can be heated at (for example, 50° C. or higher) and changed to a liquid state, and then filled.

When the curable composition 21 is filled as described above, as shown in FIG. 4(c), the curable composition 21 is disposed in the above gap between the substrate 12 and the semiconductor chip 13 so that it is in thermal contact with the substrate 12, the semiconductor chip 13 and the connecting part 15.

Next, when the curable composition 21 is cured, as shown in FIG. 4(d), a cured product 22 (can also be called a heat storage layer or a heat storage material) of the curable composition is formed in the above gap between the substrate 12 and the semiconductor chip 13. In this manner, an article 14D including the substrate 12, the semiconductor chip (heat source) 13 provided on the substrate 12, the plurality of connecting parts 15 that connect the semiconductor chip 13 to the substrate 12, and the cured product (the heat storage layer or the heat storage material) 22 of the curable composition that is provided so that it fills gaps formed by the substrate 12, the semiconductor chip (heat source) 13 and the plurality of connecting parts 15 is obtained.

A method of curing the curable composition 21 may be a method of curing the curable composition 21 by heating the disposed curable composition 21 when the curable composition 21 contains a thermal polymerization initiator. The method of curing the curable composition 21 may be a method of curing the curable composition 21 by emitting light (for example, light having at least a part of wavelengths of 200 to 400 nm (ultraviolet light)) to the curable composition 21 when the curable composition 21 contains a photopolymerization initiator. The curing method may be a combination of one or two or more of these methods.

In the above embodiments, the heat storage material 1 (the cured product 22 of the curable composition) is disposed so that it is in direct contact with the semiconductor chip 13 as a heat source, but the heat storage material and the cured product of the curable composition simply need to be in thermal contact with the heat source, and in another embodiment, for example, it may be disposed so that it is in thermal contact with the heat source with a thermally conductive member (such as a heat dissipation member) therebetween.

### EXAMPLES

While the present invention will be described below in more detail with reference to examples, the present invention is not limited to the following examples.

### [Synthesis of Compound (A-1)]

A 500 mL flask including a stirrer, a thermometer, a nitrogen gas inlet pipe, a discharge pipe and a heating jacket was used as a reaction container, 120 g of polyethylene glycol #8000 (weight average molecular weight: 8,000, commercially available from Sanyo Chemical Industries, Ltd.), and 300.0 g of toluene were put into the reaction container, and stirred at 45° C. and a stirring rotation rate of 250 rpm, nitrogen was caused to flow at 100 mL/min, and stirring was performed for 30 minutes. Then, the temperature was lowered to 25° C., and after the temperature lowering was completed, 2.9 g of acryloyl chloride was added dropwise to the reaction container, and the mixture was stirred for 30 minutes. Then, 3.8 g of trimethylamine was added dropwise and the mixture was stirred for 2 hours. Then, the temperature was raised to 45° C., and reacted for 2 hours. The reaction solution was filtered, and the filtrate was desolubilized to obtain a compound (A-1) represented by the following Formula (1-3) and having a weight average molecular weight of 8,000.

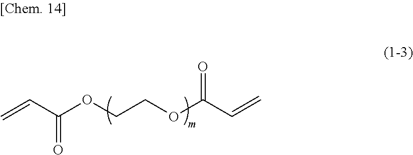

### [Synthesis of Compound (A-2)]

A compound (A-2) represented by Formula (1-3) and having a weight average molecular weight of 6,000 was obtained in the same manner as in the compound (A-1) except that 90 g of polyethylene glycol #6000 (weight average molecular weight: 6,000, commercially available from Alfa Aesar) was used in place of 120 g of polyethylene glycol #8000.

### [Synthesis of Compound (A-3)]

A compound (A-3) represented by Formula (1-3) and having a weight average molecular weight of 4,000 was obtained in the same manner as in the compound (A-1) except that 60 g of polyethylene glycol #4000 (weight average molecular weight: 4,000, commercially available from Sanyo Chemical Industries, Ltd.) was used in place of 120 g of polyethylene glycol #8000.

### [Synthesis of Compound (A-4)]

A compound (A-4) represented by Formula (1-3) and having a weight average molecular weight of 2,000 was obtained in the same manner as in the compound (A-1) except that 30 g of polyethylene glycol #2000 (weight average molecular weight: 2,000, commercially available from Sanyo Chemical Industries, Ltd.) was used in place of 120 g of polyethylene glycol #8000.

### [Synthesis of Compound (A-5)]

A compound (A-5) represented by Formula (1-3) and having a weight average molecular weight of 2,000 was obtained in the same manner as in the compound (A-1) except that 15 g of polyethylene glycol #1000 (weight average molecular weight: 1,000, commercially available from Sanyo Chemical Industries, Ltd.) was used in place of 120 g of polyethylene glycol #8000.

In the examples, in addition to the above compounds (A-1) to (A-5), the following components were used.

(B-1) Lauroyl peroxide (thermal polymerization initiator)
(B-2) 2-Hydroxy-2-methyl-1-phenyl-propan-1-one (photopolymerization initiator, commercially available from BASF “Irgacure 1173”)
(C-1) Methoxypolyethylene glycol acrylate (weight average molecular weight: 1,000, commercially available from Shin-Nakamura Chemical Co., Ltd.)
(C-2) Methoxypolyethylene glycol acrylate (weight average molecular weight: 1,500, commercially available from Shin-Nakamura Chemical Co., Ltd.)
(C-3) Methoxypolyethylene glycol acrylate (weight average molecular weight: 2,000, commercially available from Shin-Nakamura Chemical Co., Ltd.)
(C-4) Methyl methacrylate
(D-1) Polyethylene glycol (weight average molecular weight: 1,500, commercially available from Sanyo Chemical Industries, Ltd.)
(D-2) Polyethylene glycol (weight average molecular weight: 1,300, commercially available from Sanyo Chemical Industries, Ltd.)
(D-3) Polyethylene glycol (weight average molecular weight: 1,200, commercially available from Sanyo Chemical Industries, Ltd.)
(D-4) Heat storage capsule (commercially available from Outlast Technology LLC, BA410xxP, C37)
(E) Phenolic antioxidant (“ADK STAB AO-80” commercially available from ADEKA)

### [Production of Heat Storage Material]

### Examples 1 to 32

According to formulation proportions shown in Tables 1 to 3, respective components were heated and mixed at 50° C. to obtain curable compositions. Next, under a condition of 50° C., using a bar coater, the curable composition was applied onto a PET film so that the thickness after curing was 200 μm, and heated at 120° C. for 2 hours using an inert gas oven purged with nitrogen to obtain a heat storage material (a cured product of the curable composition).

### Examples 33 to 34

According to formulation proportions shown in Table 3, respective components were heated and mixed at 50° C. to obtain curable compositions. Next, a release PET film was placed on a blue plate glass so that the release surface was on the top (side opposite to the blue plate glass), four sides were bonded together with a tape cut out to a thickness of 200 μm as a spacer, and a recess (dam) was formed in the center portion. The curable composition was placed in the center portion, the release PET film was provided thereon so that the release surface was in contact with the curable composition to obtain a laminate. Next, the laminate was squeegeed so that the surface of the release PET film was in parallel with the blue plate glass, and the laminate was then subjected to UV emission under conditions of an illumination of 100 mW/cm² and a dose of 3,000 mJ/cm² using a metal halide lamp to obtain a heat storage material (a cured product of the curable composition).

### [Evaluation of Melting Point and Heat Storage Capacity]

The heat storage materials (cured products) produced in the examples were measured using a differential scanning calorimeter (model number DSC8500 commercially available from PerkinElmer Co., Ltd.), and the melting point and the heat storage capacity were calculated. Specifically, the temperature was raised to 100° C. at 20° C./min, and the temperature was kept at 100° C. for 3 minutes, and the temperature was then lowered to −30° C. at a rate of 10° C./min, and next, the temperature was kept at −30° C. for 3 minutes, and the temperature was then raised to 100° C. again at a rate of 10° C./min, and thus thermal behavior was measured. The melting peak was used as a melting point of the heat storage material, and the area was used as the heat storage capacity. The results are shown in Tables 1 to 3.

[Evaluation of flexibility]

A heat storage material (a cured product of the curable composition) having a thickness of 200 μm was bent, if it could be bent, it was evaluated as A, and if it cracked during bending, it was evaluated as B. The results are shown in Tables 1 to 3.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Formulation | A-1 | 98 | — | — | — | 50 | 100 | 100 | — | — | — | 60 |
| proportion | A-2 | — | 98 | — | — | — | — | — | 100 | — | — | — |
| (parts by mass) | A-3 | — | — | 98 | — | — | — | — | — | 100 | — | — |
| | A-4 | — | — | — | 98 | — | — | — | — | — | 100 | — |
| | A-5 | — | — | — | — | — | — | — | — | — | — | 40 |
| | B-1 | 0.1 | 0.1 | 0.1 | 0.1 | 0.1 | 0.1 | 0.1 | 0.1 | 0.1 | 0.1 | 0.1 |
| | C-3 | — | — | — | — | 50 | — | — | — | — | — | — |
| | C-4 | 2 | 2 | 2 | 2 | — | — | — | — | — | — | — |
| | D-2 | — | — | — | — | — | 100 | 400 | 400 | 400 | 400 | 400 |

| | | | | | | | | | | | |
|---|---|---|---|---|---|---|---|---|---|---|---|
| Melting point (° C.) | 44.7 | 43.2 | 41.5 | 36 | 43.5 | 44.2 | 42.0 | 41.8 | 41.7 | 41.7 | 36.8 |
| Heat storage capacity (J/cm³) | 113 | 110 | 105 | 80 | 190 | 150 | 190 | 185 | 172 | 154 | 186 |
| Flexibility | A | A | A | A | A | A | A | A | A | A | A |

TABLE 2

| | | Example | | | | | | | | | |
|---|---|---|---|---|---|---|---|---|---|---|---|
| | | 12 | 13 | 14 | 15 | 16 | 17 | 18 | 19 | 20 | 21 |
| Formulation proportion | A-1 | 2.5 | 5 | 5 | 5 | 10 | 20 | 50 | 50 | 50 | 26.5 |
| (parts by mass) | A-5 | — | — | — | — | — | — | — | — | — | 7 |
| | B-1 | 0.1 | 0.1 | 0.1 | 0.1 | 0.1 | 0.1 | 0.1 | 0.1 | 0.1 | 0.1 |
| | C-1 | 95.5 | 93 | 93 | 93 | 88 | 78 | 48 | 48 | 48 | 36.5 |
| | C-2 | — | — | — | — | — | — | — | — | — | 30 |
| | C-4 | 2 | 2 | 2 | 2 | 2 | 2 | 2 | 2 | 2 | — |
| | D-1 | — | — | 42.9 | 42.9 | — | — | — | 42.9 | 42.9 | — |
| | D-2 | — | — | — | — | — | — | — | — | — | 233 |
| | D-4 | — | — | — | 143 | — | — | — | — | 143 | — |

| | | | | | | | | | | |
|---|---|---|---|---|---|---|---|---|---|---|
| Melting point (° C.) | 40.8 | 40.6 | 42.5 | 34.1 | 40.6 | 40 | 39.9 | 47.5 | 32.4 | 40 |
| Heat storage capacity (J/cm³) | 149 | 143 | 168 | 160 | 154 | 150 | 133 | 157 | 160 | 180 |
| Flexibility | B | B | B | B | A | A | A | A | B | A |

TABLE 3

| | | Example | | | | | | | | | | | | |
|---|---|---|---|---|---|---|---|---|---|---|---|---|---|---|
| | | 22 | 23 | 24 | 25 | 26 | 27 | 28 | 29 | 30 | 31 | 32 | 33 | 34 |
| Formulation | A-1 | 5 | 20 | 40 | 50 | 50 | 50 | 50 | 50 | 40 | 40 | 40 | 50 | 50 |
| proportion | B-1 | 0.1 | 0.1 | 0.1 | 0.1 | 0.1 | 0.1 | 0.1 | 0.1 | 0.5 | 0.5 | 0.5 | — | — |
| (parts by mass) | B-2 | — | — | — | — | — | — | — | — | — | — | — | 0.25 | 0.25 |
| | C-3 | 93 | 78 | 58 | 48 | 48 | 48 | 48 | 48 | 58 | 58 | 58 | 48 | 48 |
| | C-4 | 2 | 2 | 2 | 2 | 2 | 2 | 2 | 2 | 2 | 2 | 2 | 2 | 2 |
| | D-1 | — | — | — | — | 42.9 | 53.9 | 66.7 | 42.9 | — | 53.9 | 53.9 | — | 66.7 |
| | D-4 | — | — | — | — | — | — | — | 143 | — | — | — | — | — |
| | E | — | — | — | — | — | — | — | — | — | — | 4.6 | 4.6 | 4.6 |

| | | | | | | | | | | | | | |
|---|---|---|---|---|---|---|---|---|---|---|---|---|---|
| Melting point (° C.) | 52.4 | 51.4 | 48.2 | 48.7 | 50.4 | 52.9 | 52.1 | 32.5 | 46.8 | 51.4 | 54.7 | 44.7 | 40.6 |
| Heat storage capacity | 165 | 168 | 154 | 151 | 179 | 184 | 194 | 160 | 150 | 170 | 182 | 150 | 179 |
| (J/cm³) | | | | | | | | | | | | | |
| Flexibility | B | A | A | A | A | A | A | B | A | A | A | A | A |

Based on the above examples, it can be understood that each curable composition can form a heat storage material having an excellent heat storage capacity.

### REFERENCE SIGNS LIST

1, 1A, 1B Heat storage material
2 Heat storage layer
3 Adhesive layer
11A, 11B Electronic component
12 Substrate
13 Semiconductor chip (heat source)
14A, 14B, 14C, 14D Article
15 Connecting part
16 Syringe
21 Curable composition
22 Cured product of curable composition (heat storage material)

1. A curable composition comprising a compound represented by the following Formula (1) and a polymerization initiator: 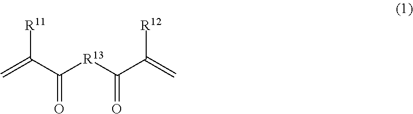
in Formula (1), R¹¹ and R¹² each independently represent a hydrogen atom or a methyl group, and R¹³ represents a divalent group having a polyoxyalkylene chain.

2. The curable composition according to claim 1, comprising a compound having a weight average molecular weight of 2,000 or more and represented by Formula (1) as the compound represented by Formula (1).

3. The curable composition according to claim 1,
wherein the compound represented by Formula (1) is a compound represented by the following Formula (1-2): 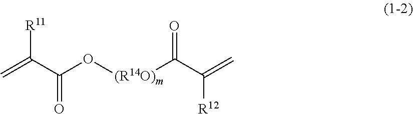
in Formula (1-2), R¹¹ and R¹² are the same as R¹¹ and R¹² in Formula (1), R¹⁴ represents an alkylene group, and m represents an integer of 2 or more.

4. The curable composition according to claim 3, wherein m is an integer such that the molecular weight of the compound represented by Formula (1-2) is 2,000 or more.

5. The curable composition according to claim 1, wherein the content of the compound represented by Formula (1) with respect to a total amount of the curable composition is 10 mass % or more.

6. The curable composition according to claim 1, further comprising a compound represented by the following Formula (2): 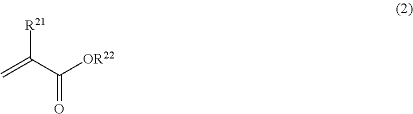
in Formula (2), R²¹ represents a hydrogen atom or a methyl group, and R²² represents a monovalent group having a polyoxyalkylene chain.

7. The curable composition according to claim 1, further comprising a heat storage component.

8. The curable composition according to claim 7, wherein the heat storage component contains polyalkylene glycol.

9. The curable composition according to claim 1, further comprising a compound represented by the following Formula (3): 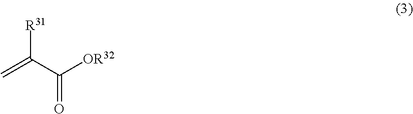
in Formula (3), R³¹ represents a hydrogen atom or a methyl group, and R³² represents an alkyl group.

10. The curable composition according to claim 1, further comprising a compound represented by the following Formula (4): 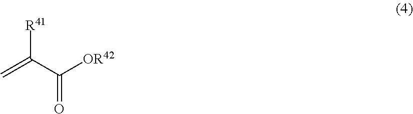
in Formula (4), R⁴¹ represents a hydrogen atom or a methyl group, and R⁴² represents a monovalent group having a reactive group.

11. The curable composition according to claim 10, further comprising a curing agent that is able to react with the reactive group.

12. The curable composition according to claim 1, which is used for forming a heat storage material.

13. A heat storage material comprising a cured product of the curable composition according to claim 1.

14. An article comprising:
a heat source; and
a cured product of the curable composition according to claim 1, which is provided in thermal contact with the heat source.
